(19) United States
(12) Patent Application Publication
(10) Pub. No.: US 2016/0144660 A1
(43) Pub. Date: May 26, 2016

(54) CYCLE WHEEL RIM AND MANUFACTURING METHOD THEREFOR

(71) Applicant: MAVIC S.A.S., Metz-Tessy (FR)

(72) Inventors: Jean-Pierre MERCAT, Chavanod (FR); Christophe NEYROUD, Cran-Gevrier (FR)

(73) Assignee: MAVIC S.A.S., Metz-Tessy (FR)

(21) Appl. No.: 14/952,137

(22) Filed: Nov. 25, 2015

(30) Foreign Application Priority Data
Nov. 26, 2014 (FR) 14/02679

(51) Int. Cl. B60B 21/10; B60B 1/00; B21D 53/30; C22C 21/02; C22C 21/08; B60B 21/02; B60B 1/04

(52) U.S. Cl. CPC B60B 21/104; B60B 21/025; B60B 1/003; B60B 1/041; B60B 1/006; C22C 21/02; C22C 21/08; B21D 53/30; B60B 2310/211; B60B 2310/214; B60B 2310/226; B60B 2310/232; B60B 2360/104; B60B 2900/111

(57) ABSTRACT

A cycle wheel rim adapted to receive an open tire. The rim has a U-shaped radial cross section, with two sidewalls located on opposite sides of a median plane of the rim, and a lower bridge connecting the sidewalls. An upper bridge connects the sidewalls to form a closed contour. The upper bridge includes a median zone extending on opposite sides of the median plane. In the median zone and on a circumferential portion of the rim greater than or equal to 50% of its circumference, a reduced thickness of the upper bridge is less than 0.75 mm, or in an alternative embodiment, less than 0.65 mm.

### CROSS-REFERENCE TO RELATED APPLICATION

This application is based upon French Patent Application No. 14/02679, filed Nov. 26, 2014, the disclosure of which is hereby incorporated by reference thereto in its entirety, and the priority of which is claimed under 35 U.S.C. §119.

### BACKGROUND

1. Field of the Invention

The present invention relates to a rim for a cycle wheel, and a method for manufacturing such a rim.

2. Background Information

Conventionally, a rim for a cycle wheel is annular and has a U-shaped radial cross section, with two lateral flanges that are generally perpendicular to the axis of rotation of the wheel, and a bridge that connects the lateral flanges and is oriented so as to be opposite the axis of rotation of the wheel. In the case of a spoked wheel, the spokes are generally fastened around the rim.

Cycle wheels equipped with air-inflated tires have been since the early twentieth century. There are two families of tires for bicycles, including tubular tires, commonly referred to as “tubular tires”, and beaded tires, commonly referred to as “clincher tires,” or “open tires”.

The patent document EP-0 893 280-A1, and family member U.S. Pat. No. 6,257,676-B1, disclose a flanged rim that is designed for a so-called “tubeless” assembly, or in other words, with a tubeless beaded tire. In their upper portions, the lateral flanges of the rim profile have a hooked portion whose function is to retain the beads of the tire, which are inextensible.

Conventionally, inextensible beads include rigid beads, for example, made of steel, and flexible beads, for example made of Kevlar, which enable the tire to be bent to facilitate its transport.

A rim designed to receive a tire having inextensible beads is subject to compressive forces resulting from the inflation of the tire. For example, for an inflation to 10 bars, the components of these forces parallel to the axis of the wheel are very substantial, typically on the order of 28 kN. A minimum mechanical strength is required because the lateral flanges and lips are directly subjected to these compressive forces. Consequently, in the case of a metal rim, the structure of the upper portion of the rim, namely the lips, the lateral flanges, and the upper bridge must have a relatively large wall thickness to withstand the mechanical stresses generated by the tire pressure.

Furthermore, to enable the mounting of the tire on the rim by passing the beads over the flanges, the upper portion of the rim profile must have a particular geometry. Indeed, to be able to pass a bead over a flange at a point on the rim, the assembly formed by the flanges and the upper bridge must have, at the diametrically opposite point, a recessed shape having a sufficiently large depth.

To enable a large number of tires to be easily assembled to a large number of rims, the European Tire and Rim Technical Organization (ETRTO) has proposed a standard that requires a minimum depth of 7.7 mm for the upper portion of the rim profile. The greater the depth, and in particular the higher the lateral flanges, the stronger the flanges and the upper bridge must be because the flanges are cantilevered with respect to the upper bridge and, therefore, they are subjected to combined bending and tensile stresses.

In addition, for a simple and relatively economical manufacture of metal rims, it is known to use an extrusion process to create a rectilinear section, which is then bent to produce the circular rim shape. In this process, the minimum thickness of the rim walls is limited by the extrusion process, which requires a thickness of at least 0.8 mm in the case of a relatively strong metal alloy. Additionally, during bending, the rim walls must be sufficiently thick to avoid being deformed. Finally, to butt weld the ends of the section, it is necessary to provide a minimum thickness of about 0.8 mm to 0.9 mm.

For lightening the rims without causing manufacturing defects, it is known to remove material after bending the rim blank and joining the ends thereof. The patent document EP-0 715 001-A1 proposes to remove material by etching. Alternatively, the patent document EP-1 084 868-A1, and family member U.S. Pat. No. 6,402,256-B1, proposes to remove material by mechanical machining. These solutions involve reducing the thickness only in the area of the lower bridge and/or the lateral flanges of the rim, in particular in the area of the zones separating two consecutive spokes. Consequently, the lightening of the rim is limited. Moreover, in the case of etching, the removal of material is carried out uniformly on all of the rim walls, and therefore affects all the zones of the rim, in particular the zones subject to strong mechanical stresses, to the same extent. Thus, it is necessary to provide a rim blank having a thick upper bridge and lateral flanges, so that these portions remain sufficiently strong after etching. Etching also has several drawbacks—it lowers the fatigue strength of the material as it generates an orange peel appearance by creating discontinuities at the grain boundaries, and etching generates alumina sludge that is costly to reprocess.

### SUMMARY

The present invention provides a new lightweight metal rim that makes it possible to remedy the aforementioned drawbacks.

To this end, the invention relates to a cycle wheel rim designed to receive an open tire, the rim having a U-shaped radial cross section, with two sidewalls located on opposite sides of a median plane of the rim, and an upper bridge connecting the sidewalls to form a closed contour, the upper bridge comprising a median zone extending on opposite sides of the median plane, wherein, in the median zone and on a circumferential portion of the rim that is greater than or equal to 50% of its circumference, a reduced thickness of the upper bridge is less than 0.75 mm or, in a particular embodiment, less than 0.65 mm.

Because of the invention, the thickness of the median zone of the upper bridge is markedly reduced, thereby making it possible to further lighten the rim compared to known rims.

According to advantageous but not essential aspects of the invention, such a rim may incorporate one or more of the following characteristics, taken in any technically permissible combination:
a width of the median zone of the upper bridge is greater than 10 mm or, in a particular embodiment, greater than 16 mm;
the rim comprises two channels located on opposite sides of the median plane and designed to receive a tire bead, and a maximum depth of the channels is less than 7.0 mm or, in a particular embodiment, less than 5.0 mm, or on the order of 3.5 mm;
the sidewalls are extended opposite the lower bridge by lateral flanges which each demarcate one side of a channel for receiving a tire bead, and a height of the lateral flanges, measured parallel to the median plane, is less than 5.0 mm or, in a particular embodiment, less than 3.6;
the rim is manufactured from an aluminum alloy comprising at least 0.6% magnesium and 0.6% silicium;
the thickness of the upper bridge is not reduced at least in the area of the spoke fastening zones, located around respective ones of the holes where the spokes are mounted, and a length of each fastening zone, measured along the circumference of the rim, is between 10 mm and 30 mm or, in a particular embodiment, between 14 mm and 20 mm;
the diameter of the rim is greater than or equal to 550 mm or, in a particular embodiment, greater than or equal to 620 mm.

The invention also relates to a method for manufacturing a cycle wheel rim comprising:
extruding or spinning a metal alloy to make a rectilinear section;
bending the section to form at least one helical coil;
optionally cutting the coils to obtain hoops;
assembly and affixing the ends of the hoop to one another; and
thinning by removing material from the upper bridge over the entire median zone in order to reduce the thickness of the upper bridge.

Advantageously, the thinning is a milling operation and the material is removed in a single pass.

### BRIEF DESCRIPTION OF DRAWINGS

The invention will be better understood and other advantages thereof will become more readily apparent from the following description of a rim according to the invention, given by way of example and with reference to the annexed drawings, in which:

FIG. 1 is a perspective side view of a wheel according to the invention, comprising a rim and a tire;

FIG. 2 is a perspective view of a section of the rim of FIG. 1;

FIG. 3 is a cross section along the plane R in FIG. 1;

FIG. 4 is a view, similar to FIG. 3, of a rim blank during manufacture;

FIG. 5 is a cross section along the plane M in FIG. 4;

FIG. 6 is a cross section, similar to FIG. 3, of the rim during manufacture;

FIG. 7 is a cross section, similar to FIG. 3, of a rim according to a second embodiment of the invention;

FIG. 8 is a cross section along the plane M in FIG. 7;

FIG. 9 is a cross section, similar to FIG. 3, of a rim blank according to a third embodiment of the invention; and

FIG. 10 is a cross-sectional view of a wheel according to a fourth embodiment of the invention.

### DETAILED DESCRIPTION

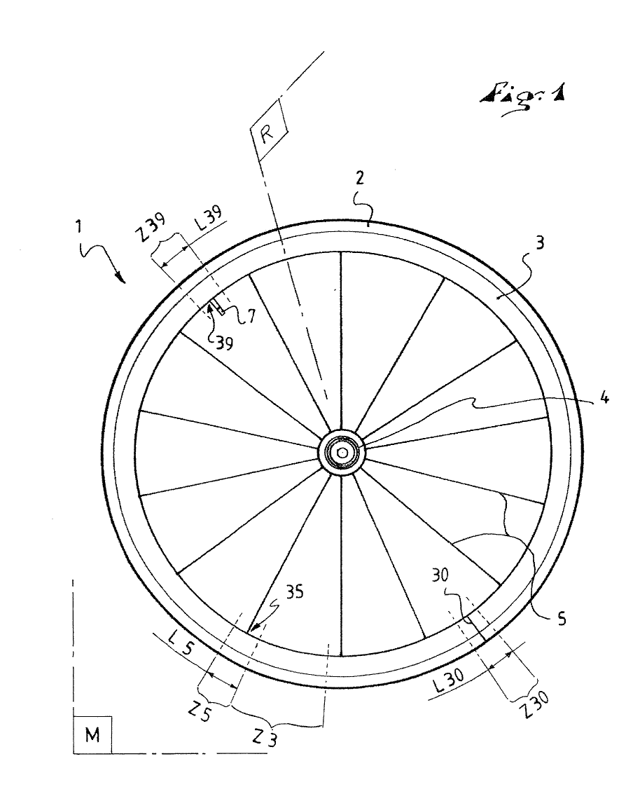

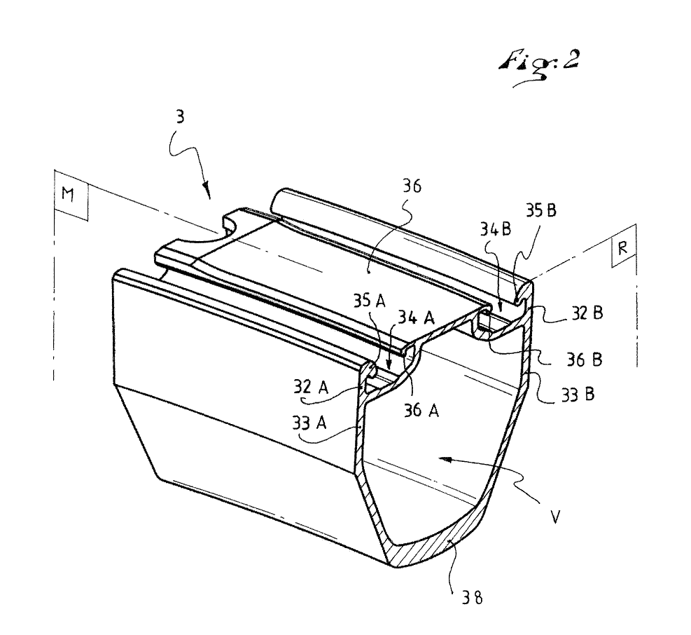

FIG. 1 shows a wheel 1 comprising a tire 2 and a rim 3, as well as a hub 4, and spokes 5. The scope of the invention is not limited to wheels equipped with tensioned spokes but also includes, for example, compression spokes, or disc wheels.

The wheel 1 is a cycle wheel. Unlike automobile wheels in particular, cycle wheels are characterized by being lighter in weight and a tire inflation pressure that can be much more substantial. Indeed, the mass of a cycle wheel seldom exceeds a few kilograms, and generally is between 1.0 kg and 4.0 kg, whereas an automobile wheel has a minimum mass of about 10 kg to 15 kg.

The invention is particularly applicable to the field of bicycle wheels for racing, particularly for road racing. Indeed, in this context, the mass of a complete wheel is less than 2.0 kg or 1.0 kg for the most efficient ones, and the inflation pressures can reach 10 bars. The invention mainly relates to racing bicycle wheels, that is to say, bicycle wheels in which the rim normalized diameter is 622 mm, possibly 584 mm or 559 mm. Such wheels are characterized by very good rigidity and minimal weight, particularly with a rim having a weight of less than 700 g or, in an alternative embodiment, less than 500 g.

The rim 3 has the shape of a closed torus centered around an axis that is the axis of rotation of the wheel 1. This torus is symmetrical in relation to a median plane M that intersects the rim 3 in two circular half-toroids. In radial cross section, this torus has the shape of a hollow casing demarcated by a lower bridge 38, an upper bridge 31, and two lateral sidewalls 33A and 33B.

A zone interfacing with the tire 2 is provided above this torus. This interface zone comprises two lateral flanges 32A and 32B extending the sidewalls 33A and 33B opposite the lower bridge 38, and a central base 36 formed by the central portion of the upper bridge 31, which projects upward in relation to the lateral portions of the upper bridge 31.

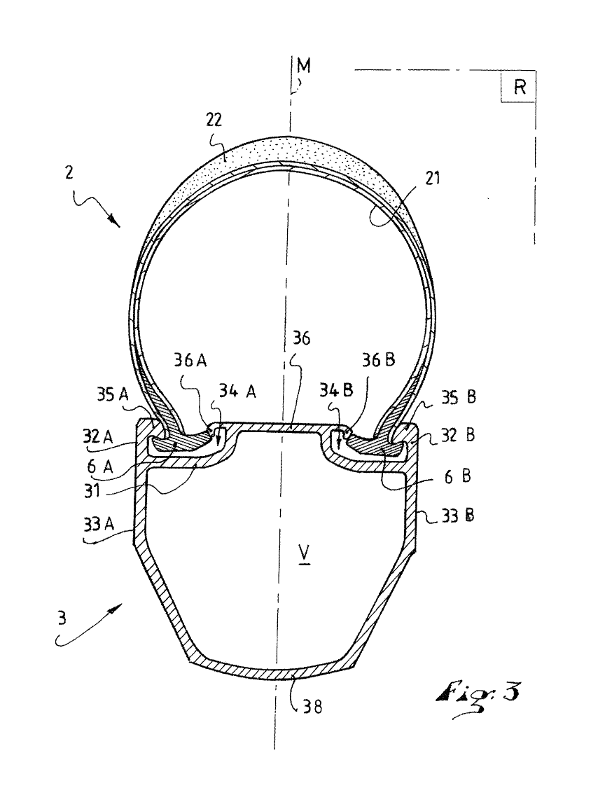

The following description makes use of directional terms such as “upward” and “downward”, which refer to the radial cross section of the wheel shown in FIG. 3. Therefore, “upward” indicates a radial direction away from the axis A of the wheel 1, whereas “downward” indicates a radial direction that is closer to the axis A. Similarly, the terms “inward” and “medial” correspond to an axial direction towards to the median plane M, whereas the terms “outward” and “lateral” correspond to an axial direction away from the median plane M. By axial direction is meant a direction parallel to the axis A.

A radial cross section is along a plane, such as the plane R, that is perpendicular to the axis A, passing through this axis.

In radial cross section, the rim 3 has a U-shape, with two generally parallel arms defined by the two sidewalls 33A and 33B, and the lower bridge 38 that connects the sidewalls. The lower bridge 38 is located on the side of the axis of rotation A of the wheel 1 in relation to the upper bridge 31. The upper bridge 31 connects the upper ends of the sidewalls 33A and 33B to form a closed box-shaped cross section, demarcating an inner volume V.

A left channel 34A is defined between the base 36 and the left lateral flange 32A. A straight channel 34B is defined between the base 36 and the right lateral flange 32B, symmetrically in relation to the median plane M.

Each channel 34A and 34B constitutes a semi-closed toric volume. For the left channel 34A, this volume is demarcated on the left by the inner surface of the left flange 32A, at the bottom by the top of the left lateral portion of the upper bridge 31, and on the right by the base 36. This volume is upwardly open. The base 36 is ended in its left portion by a stopper 36A demarcating the right end of the channel 34A.

The left flange 32A is extended by a lip 35A that is oriented downward and inward. The left flange 32A, which extends upward from the junction between the left sidewall 33A and the upper bridge 31, forms a downward bend to form the lip 35A.

The upper opening of the left channel 34A is formed at the top, between the lip 35A and the stopper 36A.

Similarly, the right channel 34B is demarcated on the right by the inner surface of the right flange 32B, at the bottom by the top of the right lateral portion of the upper bridge 31, and on the left by a stopper 36B of the base 36.

A height H of the lateral flanges 32A, 32B, measured parallel to the median plane M, is less than 5.0 mm or, in a particular embodiment, less than 3.6 mm.

An outer surface 531 of the upper bridge 31 faces opposite the axis of rotation A of the wheel 1 and is located outside of the inner volume of the rim 3. The outer surface 531 includes a median portion 536, namely the outer surface of the base 36, as well as two lateral portions 531A and 531B, namely the outer surfaces of the lateral portions 31A and 31B of the upper bridge 31.

The interface zone has a maximum depth P, which corresponds to the difference in elevation between the top of the lateral flanges and the lowermost point of the upper bridge. In the first embodiment of the invention, the maximum depth P corresponds to the difference in elevation between the bottom of the channel 34A or 34B and the top of the corresponding lateral flange 32A or 32B. The depth P is measured radially in a radial cross-sectional plane R of the rim 3, between the top of the lip 35A or 35B and the lateral outer surface 531A and 531B of the corresponding left 31A or right 31B lateral portion of the upper bridge 31. The depth P of the channel 34A is equal to that of the channel 34B.

The depth P is less than 7.0 mm or, in an alternative embodiment, less than 5.0 mm, or even on the order of 3.5 mm.

The tire 2 has the shape of an open torus. It comprises a flexible envelope 21 and two beads 6A and 6B. The envelope 21 is overlaid by a tread 22. In the embodiment described here, the envelope 21 and the tread 22 are distinct elements sewn and/or adhered, that is, adhesively affixed to one another. Alternatively, these two elements can be made in a single piece. Each bead 6A and 6B is retained in a respective one of the channels 34A and 34B, and each bead is configured to come into contact with a respective one of the lips 35A and 35B, and with a respective one of the stoppers 36A and 36B.

The rim 3 includes a valve hole 39 extending through the upper bridge 31 and lower bridge 38, and which allows the passage of an inflation valve 7. The invention is equally applicable to rims provided for mounting a conventional tire with a tube, as well as to “tubeless” rims that are provided for a tire 2 used without a tube.

The rim 3 includes a junction point 30 connecting the two ends of the section forming the rim 3. Such connection may be carried out, for example, by welding or an assembly using a sleeve housed in the inner volume V of the rim 3.

The rim 3 is divided into a plurality of zones that divide its circumference into angular sectors. The rim 3 thus includes first zones Z5 for fastening the spokes 5, located around, that is, on either side of, respective ones of the holes 35 where the spokes 5 are mounted. Two intermediate zones Z3 are located on opposite sides of each fastening zone Z5.

A length L5 of each first zone Z5, measured along the circumference of the rim 3, on the outside, is between 5.0 mm and 30 mm or, in an alternative embodiment, between 10 mm and 20 mm. A third zone extends Z39 extends around, that is, on either side of, the valve hole 39. A length L39 of the third zone Z39, measured along the circumference of the rim 3, is between 8.0 mm and 30 mm or, in an alternative embodiment, between 15 mm and 22 mm.

A fourth zone Z30 extends around, that is, on either side of, the junction 30. A length L30 of the second zone Z30, measured along the circumference of the rim 3, on the outside, is between 4.0 mm and 35 mm or, in an alternative embodiment, between 12 mm and 20 mm.

The following description relates to a method for manufacturing the rim 3.

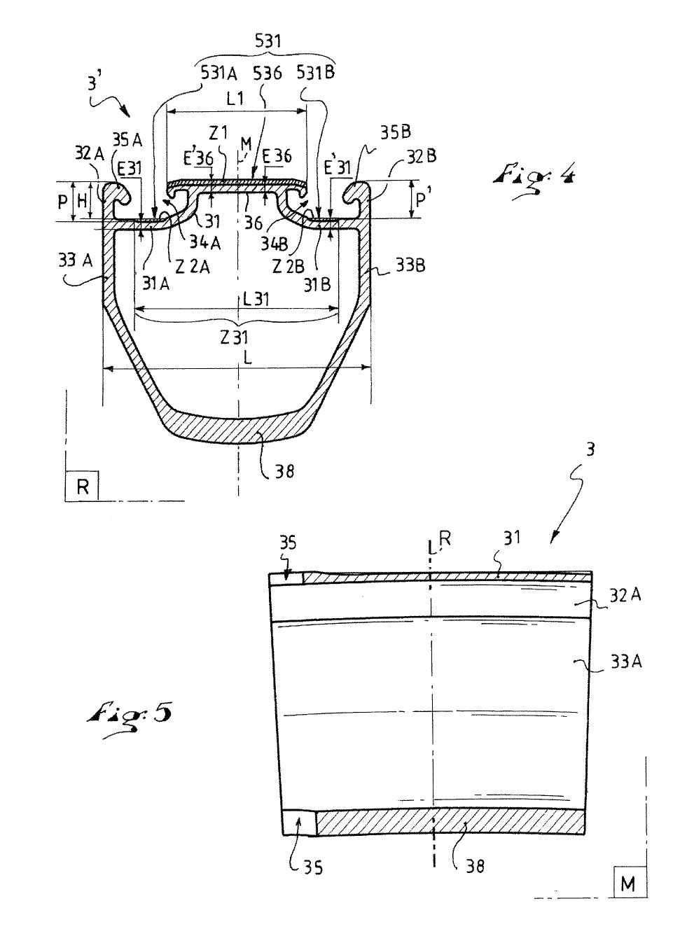

During extrusion, a rectilinear section 3′, whose radial cross section is shown in FIG. 4, is made by extruding or spinning a metal alloy such as an aluminum alloy, for example, which is alloyed with at least 0.6% magnesium and 0.6% silicium. In FIG. 4, the hatched zones Z1, Z2A, and Z2B are part of the section 3′. The radial cross section of the section 3′ is generally similar to that of the rim 3. Thus, all of its portions are not described again.

The base 36 of the section 3′ has a thickness E′36, measured along a radial direction in the median plane M, perpendicular to the longitudinal axis of the section 3′. The thickness E′36 is between 0.8 mm and 2.5 mm or, in an alternative embodiment, between 1.2 mm and 2.0 mm.

The left 31A and right 31B lateral portions of the upper bridge 31 of the section 3′ have a thickness E′31. The thickness E′31 is between 0.7 mm and 1.4 mm or, in an alternative embodiment, between 0.8 mm and 1.1 mm.

During bending, the section 3′ is bent to form at least one helical coil, for example, by means of a roller bender. For example, three coils are formed from the section 3′, which then has a total length equivalent to about three times the circumference of the rim 3.

To avoid the appearance of defects in the material of the section 3′ during the extrusion, the walls of the section 3′ should be sufficiently thick. In addition, the section 3′ may buckle during bending and undesired bends may form if its walls are too thin.

During cutting, the coils are cut to obtain a plurality of hoops having substantially the same perimeter as the rim 3.

During assembly, the ends of the hoop obtained during cutting are butt-joined and affixed to one another, for example by welding, in the area of the junction point 30.

The thickness of the section 3′, in particular the thicknesses E′31 and E′36, are sufficiently great to produce a solid weld. Indeed, if the thickness is too small, the weld becomes very difficult to achieve and may break. Moreover, for uses in tubeless mode, it is very difficult to achieve an impervious welded rim having a small wall thickness.

During drilling, the valve hole 39 is made, for example by means of a drill bit.

During thinning, a zone Z31 of the outer surface S31 of the upper bridge 31 is machined. The zone Z31 extends on both sides of the median plane M and is intersected by this plane. The zone Z31 is centered on the median plane M along an axial direction. A width L31 of the median zone Z31 of the upper bridge 31, measured parallel to the axis A, is greater than 10 mm or, in an alternative embodiment, pgreater than 16 mm.

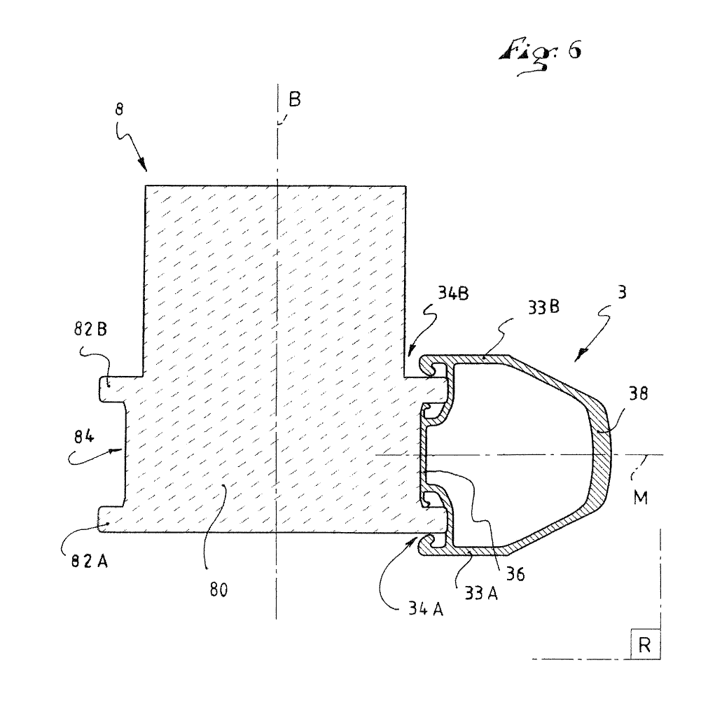

By way of example, as shown in FIG. 6, the zone Z31 is machined by means of a milling cutter 8 that includes a cylindrical body 80 centered on an axis of rotation B of the cutter milling 8. The body 80 comprises a cylindrical outer surface 84 provided with teeth and edged on both sides, along the axis B, with a hoop-shaped collar 82A or 82B provided with teeth. Thus, a recess is defined between the collars 82A and 82B, along the outer surface 84. The shape of the milling cutter 8 corresponds to the geometry of the upper bridge 31 and allows simultaneous machining of all of the portions 531A, 531B, 536 of the outer surface 531 of the thinned zone Z31. The outer surface 84 machines the median surface 536, whereas the collars 82A and 82B simultaneously machine the lateral portions 531A and 531B.

During thinning, the rim 3 is fixed in a horizontal position on a plate rotationally movable about the (vertical) axis of rotation A of the rim. The axis of rotation B of the milling cutter 8 is positioned vertically, and a robot moves the milling cutter 8 along a radial direction of the rim 3, with a short stroke corresponding to the thickness of the machined material. This simplifies the thinning process and reduces its duration, for example to less than 1-2 minutes. Thus, the manufacturing cost of the rim 3 is not substantially affected.

After thinning, the base 36 has a maximum thickness E36 and the lateral portions 31A and 31B of the upper bridge 31 a maximum thickness E31. In the example shown in the drawing figures, the final thickness E31 of the left lateral portion 31A is equal to the final thickness E31 of the right lateral portion 31B. Alternatively, the thickness E31 of the left lateral portion 31A may be different from the thickness E31 of the right lateral portion 31B.

Optionally, the final thickness E36 of the base 36 is equal to thickness E31 of the lateral portions 31A and 31B.

The thicknesses E36 and E31 are strictly less than the thicknesses E′36 and E′31, respectively.

After thinning, the final thicknesses E31 and E36 are less than or equal to 0.75 mm or, in an alternative embodiment, less than 0.65 mm. In the disclosed embodiment, the nominal thickness is approximately 0.6 mm.

In one embodiment, a single thinning step is performed. The expression “single” thinning step means herein that there is no additional thinning step reducing the thickness of the zone Z31. Of course, this machining operation may possibly be performed in two passes, a blanking pass and a finishing pass.

In another embodiment of the invention, the zones Z5 are not machined during thinning. In other words, in the area of the zones Z5, the initial thicknesses E′31 and E′36 are equal to the final thicknesses E31 and E36. Indeed, in the area of the fastening zones Z5 of the spokes 5, the rim 3 is subjected to greater mechanical stresses due to the cyclic tensile and compressive stress imposed by the spokes 5. By keeping a sufficient thickness in the area of the zones 5, fatigue cracks are avoided.

Conversely, the zones Z3 located between the spokes 5 are machined during thinning. The surface 531 of the upper bridge 31 is machined in the area of the zones Z3. The thicknesses E31 and E36 are therefore less than the thicknesses E′31 and E′36, respectively, in the area of these zones Z3. The mechanical stresses received by the rim 3 in the area of the zones Z3 are less substantial than in the area of the zones Z5 for fastening the spokes 5. Consequently, the reduction in thicknesses E31 and E36 does not negatively affect the mechanical strength of the rim 3.

In the same manner as the zones Z5 for fastening the spokes 5, the zone Z39 of the valve hole 39 and the junction zone Z30 are not machined in order to maintain satisfactory mechanical strength.

In an alternative embodiment, the zones Z5 and Z39 are less machined than the zones Z3 during thinning. Thus, as in the previously described embodiment, the thicknesses E31 and E36 in the area of the zones Z5 and Z39 are slightly less than the initial thicknesses E31′ and E36′ while being greater than the existing thicknesses in the area of the zones Z3 so as to maintain greater mechanical strength in the zones Z5 and Z39.

The thinning step is performed with a material removal process, such as milling.

The removal of material is performed on a portion of the rim 3 that is greater than or equal to 50% of its circumference. In the example described, the sum of the lengths L3 of the zones Z3, measured along the circumference of the rim 3, is greater than 50% of the total circumference of the rim 3. In a particular embodiment, the removal of material is performed on a portion of the rim 3 that is greater than or equal to 70% of its circumference.

In the case of a rim having an ETRTO diameter of 633 mm and having 36 paired spokes, that is, fastened to the rim in the vicinity of one another (they then share a common anchoring zone and do not define an inter-spoke zone therebetween), the 18 inter-spoke spaces Z3 may or may not be machined, or may be machined with a depth less than the 18 zones Z5 in which the spokes are fastened. In this case, satisfactory results are obtained by providing the zones Z5, Z39, and Z30 with an extension of 16 mm whereas the zones Z3 have an extension of 94 mm. This results in more than 80% of the perimeter of the upper bridge being machined.

In alternative embodiments, the upper bridge 31 is machined over its entire circumference (100%), i.e., the zones Z5, Z3, Z39 and Z30 are machined. However, the machine can be adjusted so that the thickness of the cutting pass is less substantial in the zones in which a satisfactory mechanical strength is to be maintained. Thus, the zones Z5, Z30 and/or Z39 may also be machined to a thickness of the upper bridge E31″ and E36″ which is greater than E31 and E36 but less than E31′ and E36′, respectively.

The decrease in thicknesses E31 and E36 makes it possible to lighten the rim 3. For example, for the final thicknesses E31 and E36 equal to 0.6 mm, the weight reduction is on the order of 25 g.

The material removal by means of the milling cutter 8, as described above, makes it possible to vary the radial distance between the milling cutter 8 and the axis of rotation A of the wheel 1, depending upon the zones Z3, Z5, Z30, and Z39 of the rim 3. This makes it possible to machine all of the desired zones in a single pass, by rotating the rim 3 about its axis A on its support.

It is known that a prior art rim, when inflated, does not have a strictly constant width over its entire circumference, due to the valve hole which causes a local weakening of the rim. Therefore, there is a local widening at a right angle with the valve hole. Consequently, frictional braking with brake pads is uneven, wear on the rim is also uneven, and vibrations are generated. Due to the invention, by removing material between the holes, the width of the rim 3 under pressure is rebalanced over its entire circumference, thereby eliminating these drawbacks.

In addition, it is not uncommon to observe incipient fatigue cracks in a valve hole drilling zone as a result of stress concentrations caused by the hole. A local increase in this thickness makes it possible to prevent this deterioration without weighing down the rim.

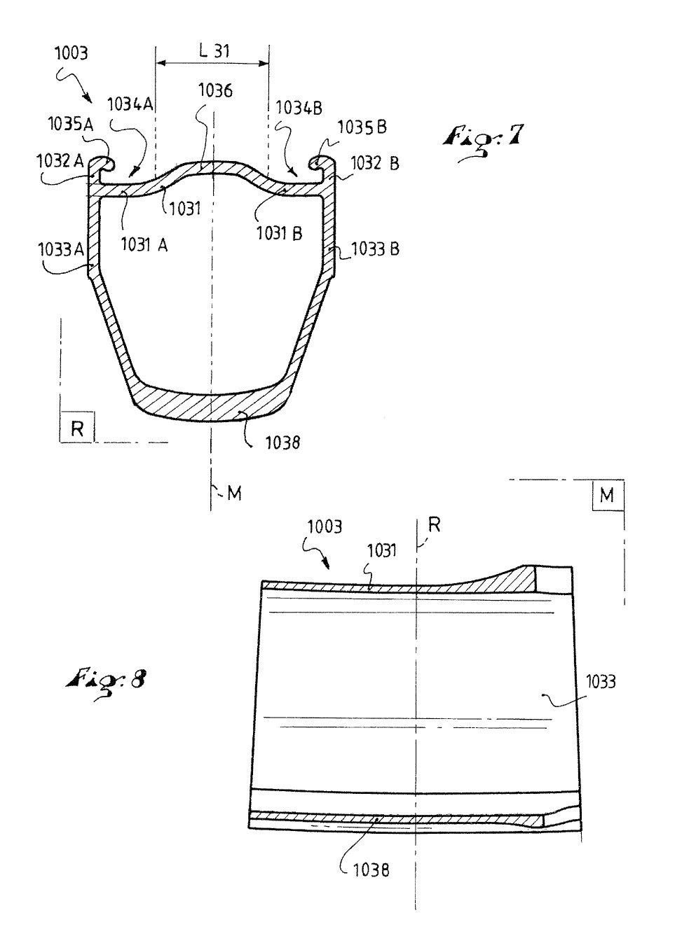

FIGS. 7 and 8 show a rim 1003 according to a second embodiment of the invention. In the following description, the elements of the rim 1003 similar to those of the rim 3 are given the same reference numerals, increased by 1000, and are not described in detail. Only the elements of the rim 1003 that differ from those of the rim 3 are described below.

Similar to the rim 3, the rim 1003 comprises a lower bridge 1038, an upper bridge 1031, and two sidewalls 1033A and 1033B which, together, demarcate a volume V of the rim 1003. The sidewalls 1033A and 1033B are extended upward by lateral flanges 1032A and 1032B ended with lips 1035A and 1035B.

The upper bridge 1031 includees a median portion 1036 and two lateral portions 1031A and 1031B. The median portion 1036 is higher than the lateral portions 1031A and 1031B so as to demarcate channels 1034A and 1034B.

The method for manufacturing the rim 1003 is similar to that described with reference to the rim 3. The geometry of the milling cutter is adapted to that of the upper bridge 1031 of the rim 1003.

As in the previous embodiment, the width L31 of the median zone which is machined is greater than 10 mm or, in an alternative embodiment, 16 mm.

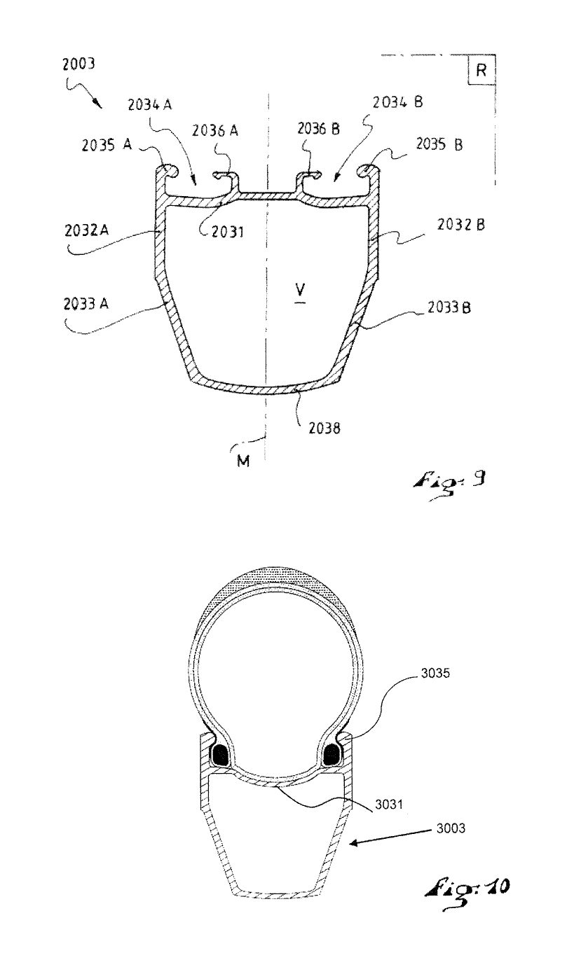

FIG. 9 shows a rim 2003 according to a third embodiment of the invention. In the following description, the elements of the rim 2003 similar to those of the rim 3 are given the same reference numerals, increased by 2000, and are not described in detail. Only the elements of the rim 2003 that differ from those of the rim 3 are described.

Similar to the rim 3, the rim 2003 comprises a lower bridge 2038, an upper bridge 2031, and two sidewalls 2033A and 2033B which, together, demarcate a volume V of the rim 2003. The sidewalls 2033A and 2033B are extended upward by lateral flanges 2032A and 2032B ended with lips 2035A and 2035B.

The upper bridge 2031 includes a median portion 2036 and two lateral portions 2031A and 2031B. The median portion 2036 comprises two projections 2036A and 2036B each ended by a stopper so as to demarcate channels 2034A and 2034B.

The method for manufacturing the rim 2003 is similar to that described with reference to the rim 3. The geometry of the milling cutter is adapted to that of the upper bridge 2031 of the rim 2003. In particular, the entire bridge 2031 can be machined, including the vertical edges of the two projections 2036A and 2036B located near the median plane, whose thickness can also be reduced to approximately 0.6 mm.

In an embodiment not shown, the rim is made of a section of aluminum alloy completed with a fairing made of composite material, as shown in the European patent document EP-2 311 650-A1 and family member US 2011/089751-A1. The lower bridge of the rim is a wall made of composite material, which is assembled using an adhesive, for example, after manufacture of the hoop from an aluminum alloy. In this case, the upper bridge of the hoop is machined prior to positioning the fairing of composite material.

FIG. 10 shows a wheel according to a fourth embodiment of the invention. This wheel comprises a rim 3003, whose profile does not include two channels as in the previous embodiments, but has a single groove. It is then possible to machine the entire width of the upper bridge 3031 to a thickness less than 0.75 mm or, in an alternative embodiment, less than 0.65 mm. This results in an even more substantial weight reduction. The depth of the groove calculated between the top of the lips 3035 and the central portion of the upper bridge is less than 5.5 mm.

In a variation of the fourth embodiment of the invention, the depth of the groove is more substantial, so as to be in compliance with the ETRTO recommendations regarding the height of the lips and of the bottom of the rim drop center. In this alternative embodiment, the lateral flanges and the upper bridge define a hollow profile whose total depth is greater than 7.7 mm. Given the depth of the hollow profile and the substantial lateral forces that the tire beads can exert on the flanges, one can then consider limiting the depth of machining passes. However, to maintain a consistent weight reduction, that is, to reduce the thickness of the upper bridge as much as possible, much stronger materials, for example aluminum alloys such as alloys 6053, 6069, 7108, or 2196, can be used. This is a non-exhaustive list.

The present invention is not limited to the embodiments shown in the drawing figures. Furthermore, the characteristics and variations of the various embodiments may be combined, at least partially, within the scope of the invention.

The invention also applies to a rim whose upper bridge is pierced to allow passage of the spoke nipples. In this case, it is even more advisable not to machine or to limit the machining in the zone Z30 comprising the drilling hole of the upper bridge in order to limit the local deformation due to the hole, and to limit the stress concentrations associated with the hole.

Lastly, at least because the invention is disclosed herein in a manner that enables one to make and use it, by virtue of the disclosure of particular exemplary embodiments of the invention, the invention can be practiced in the absence of any additional element or additional structure that is not specifically disclosed herein.

1. A rim for a cycle wheel designed to receive an open tire and including a U-shaped radial cross section, the rim further comprising:
two sidewalls located on opposite respective sides of a median plane of the rim;
an upper bridge connecting the sidewalls, the upper bridge comprising a median zone extending on both of the sides of the median plane of the rim;
in the median zone and on a circumferential portion of the rim that is greater than or equal to 50% of the circumference of the rim, a reduced thickness of the upper bridge being less than 0.75 mm.

2. A rim according to claim 1, wherein:
in the median zone and on a circumferential portion of the rim that is greater than or equal to 50% of the circumference of the rim, a reduced thickness of the upper bridge is less than 0.65 mm.

3. A rim according to claim 1, wherein:
a width of the median zone of the upper bridge is greater than 10 mm.

4. A rim according to claim 1, wherein:
a width of the median zone of the upper bridge is greater than 16 mm.

5. A rim according to claim 1, further comprising:
two channels located on both sides of the plane median, each of the two channels being configured to receive a bead of the tire; and
wherein a maximum depth of each of the two channels is less than 7.0 mm.

6. A rim according to claim 5, wherein:
a maximum depth of each of the two channels is less than 5.0 mm.

7. A rim according to claim 5, wherein:
a maximum depth of each of the two channels is on the order of 3.5 mm.

8. A rim according to claim 1, wherein:
the sidewalls are extended opposite the lower bridge by lateral flanges which each demarcate one side of a channel for receiving a bead of the tire; and
a height of the lateral flanges, measured parallel to the median plane, is less than 5.0 mm.

9. A rim according to claim 1, wherein:
the sidewalls are extended opposite the lower bridge by lateral flanges which each demarcate one side of a channel for receiving a bead of the tire; and
a height of the lateral flanges, measured parallel to the median plane, is less than 3.6 mm.

10. A rim according to claim 1, wherein:
the rim is made from an aluminum alloy comprising at least 0.6% magnesium and 0.6% silicium.

11. A rim according to claim 1, wherein:
the upper bridge having thicknesses that are not reduced thicknesses at least in areas of spoke-fastening zones located around respective ones of holes where spokes are configured to be mounted; and
a length of each fastening zone, measured along the circumference of the rim, is between 5.0 mm and 30 mm.

12. A rim according to claim 1, wherein:
the upper bridge having thicknesses that are not reduced thicknesses at least in areas of spoke-fastening zones located around respective ones of holes where spokes are configured to be mounted; and
a length of each fastening zone, measured along the circumference of the rim, is between 10 mm and 20 mm.

13. A method for manufacturing a rim according to claim 1, the method successively comprising:
extruding or spinning a metal alloy to obtain a rectilinear section;
bending the section to form at least one helical coil;
assembling and affixing the ends of the hoop to one another; and
thinning by removing material from the upper bridge over an entirety of the median zone to reduce the thickness of the upper bridge.

14. A method according to claim 13, wherein:
the bending of the section comprises bending the section to form a plurality of helical coils; and
the method further comprises cutting the plurality of helical coils to obtain a plurality of hoops.

15. A method according to claim 13, wherein:
during the thinning, the material is removed in a single pass.

16. A method according to claim 14, wherein:
during the thinning a milling process is used.

17. A cycle wheel comprising:
a rim designed to receive an open tire and including a U-shaped radial cross section, the rim further comprising:
two sidewalls located on opposite respective sides of a median plane of the rim;
an upper bridge connecting the sidewalls, the upper bridge comprising a median zone extending on both of the sides of the median plane of the rim;
in the median zone and on a circumferential portion of the rim that is greater than or equal to 50% of the circumference of the rim, a reduced thickness of the upper bridge being less than 0.75 mm; and
an open tire.
